(19) United States
(12) Patent Application Publication
(10) Pub. No.: US 2003/0126154 A1
(43) Pub. Date: Jul. 3, 2003

(54) Information processing apparatus, information processing method, information processing program and information processing system

(76) Inventors: Kiyoshi Aida, Tokyo (JP); Tomohiko Shirahama, Tokyo (JP)

Correspondence Address: FROMMER LAWRENCE & HAUG, 745 FIFTH AVENUE- 10TH FL., NEW YORK, NY, 10151, US

(21) Appl. No.: 10/303,402

(22) Filed: Nov. 25, 2002

(30) Foreign Application Priority Data
Nov. 26, 2001 (JP) 2001-359851

(51) Int. Cl. G06F 7/00

(52) U.S. Cl. 707/104.1; 707/3

(57) ABSTRACT

An information providing apparatus by which the relevant information pertinent to a product and the additional information pertinent to the relevant information can be automatically acquired by exploiting identification codes, such as bar codes, without the need to effectuate manual retrieval. When a software, such as PC media player software, provided with the bar code readout function, is executed, a computer device 30 is booted in association with an enclosed database 31 forming a portion of an HDD to reprieve the product information corresponding to the bar codes. The computer device 30 may retrieve the product information using a bar code-content database 40 connected to outside over the network. The computer device 30 automatically acquires the relevant information over the Internet from the Web servers 41, 42 and 43, connected to the internet, based on the retrieved product information, for demonstration on a display unit 50.

### BACKGROUND OF THE INVENTION

1. Field of the Invention

This invention relates to an information processing apparatus, an information processing method, an information processing program and an information processing system in which the information pertinent to a product afforded e.g, with a bar code is acquired from w.g., a Web site on the network for demonstration.

2. Description of Related Art

Up to now, there existed a database system for retrieving data arranged as a database stored on a computer system. The user acted on the database system directly or through a terminal device connected over a network to acquire the necessary information.

For example, in order to acquire the music-related information from a terminal device, manual keyword inputting retrieval conventionally had to be performed on a retrieval site. Moreover, when a music listener desired to acquire the latest information of a performer or the supplementary information (other than the CD title information), the music listener had to connect to a network, such as the Internet, to make manual retrieval.

### SUMMARY OF THE INVENTION

In view of the above-depicted problem, it is an object of the present invention to provide an information processing apparatus, an information processing method, an information processing program and an information processing system in which the information related to a product or the additional information for the product-related information can be automatically acquired by exploiting a code, such as a bar code, from a hard disc of a computer or from a database on a network, such as the Internet, without the need to effectuate manual retrieval.

In one aspect, the present invention provides an information processing apparatus including product information retrieving means for reading out the code input by a code inputting device for retrieving the product information, relevant information acquisition means for acquiring the relearnt information pertinent to the product information retrieved by the product information retrieving means, and display means for displaying the relevant information acquired by the relevant information acquisition means.

In another aspect, the present invention provides an information processing method including a code inputting step of inputting a code, a product information retrieving step of reading out the code input from the code inputting step to retrieve the product information, a relevant information acquisition step of acquiring the relevant information pertinent to the product information as retrieved by the product information retrieving step, and a relevant information displaying step of demonstrating the relevant information acquired by the relevant information acquisition step.

In still another aspect, the present invention provides an information processing program including a code inputting step of inputting a code, a product information retrieving step of reading out the code input from the code inputting step to retrieve the product information, a relevant information acquisition step of acquiring the relevant information pertinent to the product information as retrieved by the product information retrieving step, and a relevant information displaying step of demonstrating the relevant information acquired by the relevant information acquisition step.

In yet another aspect, the present invention provides an information processing program including a code inputting step of inputting a code, a product information retrieving step of reading out the code input from the code inputting step to retrieve the product information, a relevant information acquisition step of acquiring the relevant information pertinent to the product information as retrieved by the product information retrieving step, and a relevant information displaying step of demonstrating the relevant information acquired by the relevant information acquisition step.

Thus, with the present information processing apparatus, the product information can be acquired from a hard disc of a computer or a database (DB) on the Internet, by exploiting, for example, the bar code information, to acquire the relevant information pertinent to the product from the so produced product information. On the other hand, the latest information, additional information or the supplementary information on a performer can automatically be acquired from a Web site on the internet based on the so produced relevant information.

That is, according to the present invention, the relevant information pertinent to a product or the additional information to the relevant information can automatically be acquired from a database, exemplified by a hard disc of a computer, or by a network, such as the Internet, without manual retrieval, by exploiting an identifying code, such as a bar code.

### BRIEF DESCRIPTION OF THE DRAWINGS

FIG. 1 shows the structure of an information processing system embodying the present invention.

FIG. 2 is a block diagram showing the structure of a computer device included in the information processing system.

FIG. 3 is a flowchart for illustrating the operation of the information processing system, centered about a computer device.

FIG. 4 is another flowchart, similar to the flowchart shown in FIG. 3, for illustrating the operation of the information processing system, centered about a computer device.

### DESCRIPTION OF THE PREFERRED EMBODIMENT

Referring to the drawings, a preferred embodiment of the present invention will be explained in detail.

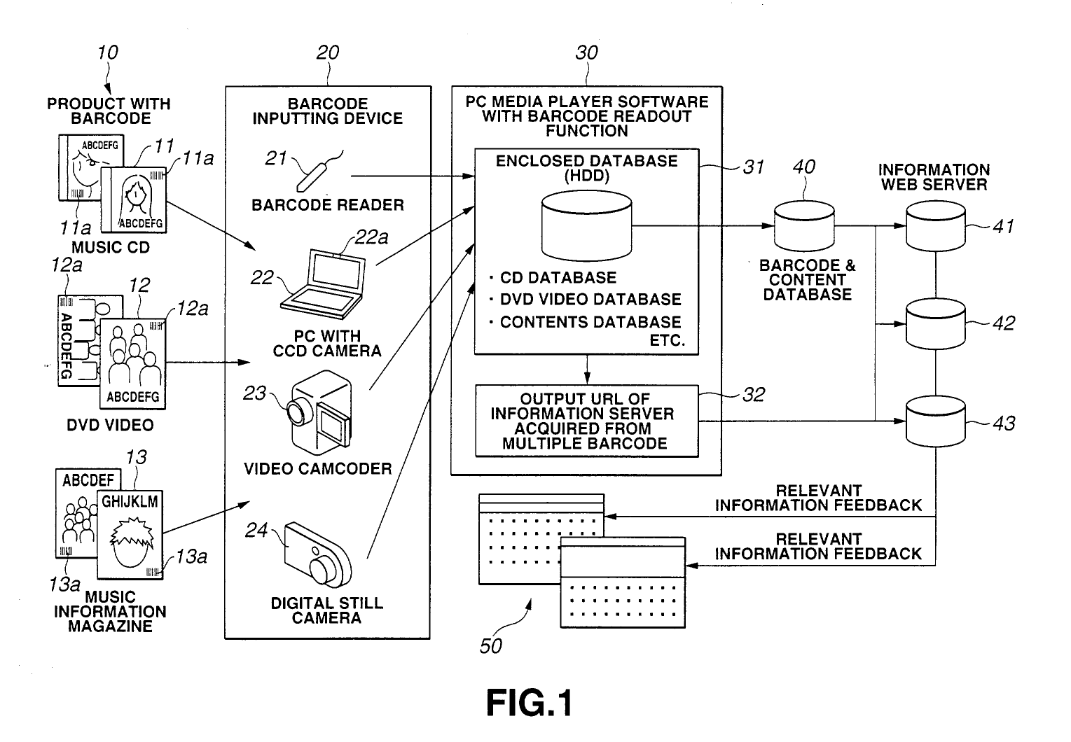

The present embodiment is directed to an information processing system for automatically acquiringthe relevant information or the additional information from the Web site on the Internet by taking advantage of the bar code information read out from a product carrying a bar code, as typical of an identifying code, that is a bar code carrying product 10, as shown in FIG. 1.

As typical of the bar code carrying product 10, there may be recited a music CD 11, a DVD video 12 and a music information magazine 13, carrying bar codes 11a, 12a and 13a, respectively.

The bar code represents the product information for supervising a product, such as a producer's name or a product's name, by the combination of bars of different widths. The bar code has its striped pattern read out by an optical detection method. Inherently, the bar codes were used for imputing the information to a computer device. In this nation, what is termed the JAN (Japanese Article Number) code is extensively used.

The present information processing system is made up by a bar code inputting device 20, for inputting the bar code carrying product 10, a computer device 30 for reading out the bar code input by the bar code inputting device 20 to retrieve the product information as well as to acquire the relevant information from the product information, an Internet connection environment, and information Web servers 41, 42 and 43.

When the product is a music CD, the product information, represented by the bar code, is the information for supervising the product, such as the producer's name or the product's name. The relevant information includes such information pertinent to the hysteresis of the performing artists, co-performers, site of a studio where the CD was produced, and the album number. The artist's comments or the fan's comments may also be introduced. The relevant information includes the concert ticket information or the music score number, as will be explained subsequently. The additional information may also include the information on the state of the goods' sale as well as the information on fan clubs.

Moreover, this information processing system may include a bar code-content database 40, a printer, not shown, and so forth.

The bar code inputting device 20 inputs the bar code to the computer device 30 by its optical detecting function. Specifically, the bar code inputting device 20 may use a bar code reader 21, a PC 22 having a CCD camera 22a, a video camcorder 23 or a digital still camera 24. Of course, key codes representing the bar codes may be input from e.g., a keyboard.

The computer device 30 first reads out the bar codes input by the bar code inputting device 20 to retrieve the product information. For example, when an application software, such as a PC media player fitted with the bar code provided with the bar code readout function, an enclosed database 31, employing a portion of the HDD, is concomitantly booted to retrieve the product information associated with the bar code. This enclosed database 31 is made up by for example a CD database, a DVD video database and a content database. The computer device 30 may also retrieve the product information using the bar code-content database 40 connected to outside over the Internet.

First, the computer device 30 automatically acquires the relevant information from the Web servers 41, 42 and 43, via Internet browser, based on the retrieved product information, to demonstrate the so acquired information on a display device 50. The operation of this computer device 30 will be explained subsequently.

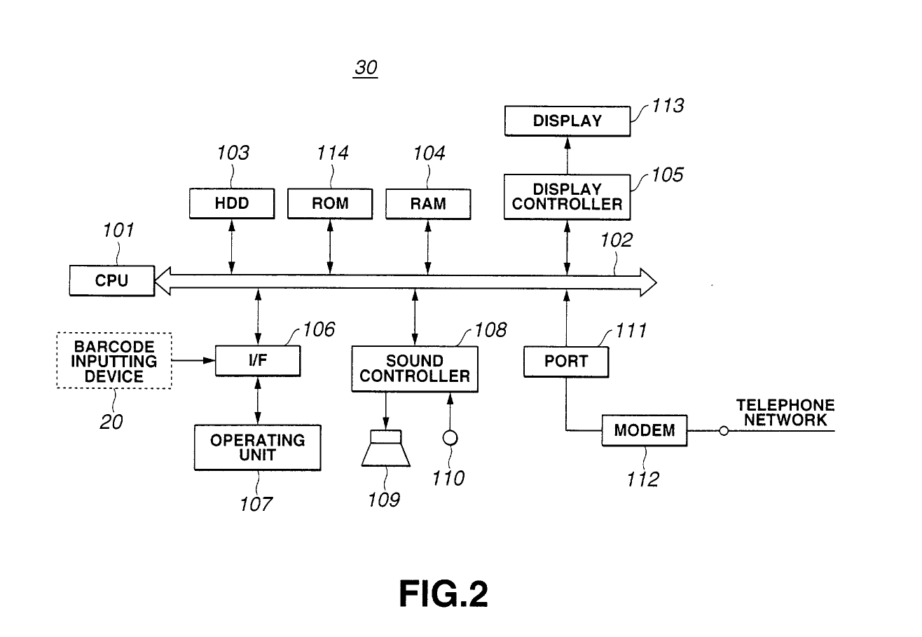

FIG. 2 shows the structure of the computer device 30.

The computer device 30 is of a micro-processor configuration. That is, in the computer device 30, a CPU 101, an HDD 103, a ROM 114, a work area RAM 104, a display controller 105, an I/F 106, associated with an operating unit and with the bar code inputting device 20, a sound controller 108 and an input/output port 111.

To the display controller 105, there is connected a display 113 (display device 50 of FIG. 1), whereas, to the I/F 106, there are connected an operating unit 107, such as a keyboard, a mouse or a key pad, and the aforementioned bar code inputting device 20. To the sound controller 108, there are connected a loudspeaker 109 and a microphone 110.

To the input/output port 111 is connected a modem 112, which modem 112 is connected to a telephone network on inserting a modular plug into a modular plug, not shown. The computer device 30 is connected to the Internet by this modem 112 over the telephone network.

The computer device 30 also includes a drive device for reproducing the music CD or the DVD video.

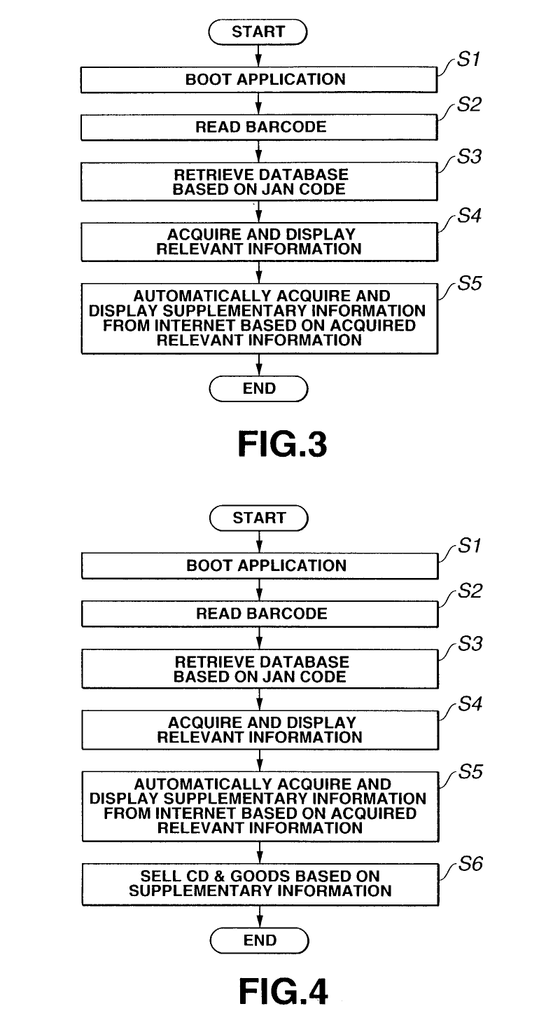

Referring to FIG. 3, the operation of the above-described information processing system, centered about the computer device 30, is now explained, by way of a specified example of the information processing method and the information processing program according to the present invention. The information processing program is stored, along with the other application software items, in the HDD 103 or in the ROM 114.

First, the application, such as the aforementioned PC media player software provided with the bar code readout function, stored in the HDD 103 or in the ROM 114, is booted (step S1). The computer device 30 then reads out the bar code entered by the bar code inputting device 20 (step S2).

The computer device 30 then retrieves the enclosed database 31 or the bar code-content database 40, using e.g., the JAN as a retrieving key (step S3) to retrieve the product information on the CD, DVD and so forth.

The computer device 30 then acquires the relevant information, using the aforementioned product information, to display the so acquired information on the display 113 (step S4).

The computer device 30 at step S5 connects to for example the Web site 41 of a different company over the Internet, based on the above-mentioned related information, to automatically acquire the supplementary information or the additional information, for demonstration on the display 113.

Examples of the supplementary information or the additional information, automatically acquired on connection to the site of the other company at step S5, include the new CD/EMD release information, live concert information, promotion video content, promotion audio content, URL of the Web page for artist's promotion, hit music or video information and so forth.

It is also possible to have the computer device 30 sell CDs or goods at step S6 based on the supplementary information or the additional information, as shown in FIG. 4.

It is also possible to permit the Web site of the different company to have business negotiation depending on the number of times of access from the present service or the number of goods sold.

Certain specified events that can be realized with the present embodiment of the information processing system are now explained.

A first specified event is such a one in which, when the bar code stated on a package of the music CD or DVD is read, the product information is acquired from the DB held in the HDD or from the content DB on the Internet, and a server on the Internet, havingthe relevant content information, is accessed, based on the so acquired information, to automatically display the pertinent product or the relevant artist information on the Internet browser. The discography, profile, liner notes, oeuvre information, concert ticket information, music note information, EMD information and the CD purchasing information, are automatically displayed.

A second specified event is such a one in which the information wine-pressed from the information pertinent to both of the product carrying the bar code and the music CD, from plural keys, such as CDTOC+bar codes, for retrieval, in order to automatically display the relevant information on the Internet browser. From the bar code afforded to the freshening beverage and from the TOC of the music CD, the sponsor site of the CM the artist is acting in or an official page of a drama the artist is acting in is automatically displayed by way of guiding the user.

A third specified event is such a one in which the system causes the bar code stated on the package of the music CD to be read to access the server on the Internet having the content information based on the so read out information to automatically reserve for recording the TV drama the artist is acting in by the PC video function. Based on the music CD, the program EPG the actor is performing in may be automatically displayed to permit automatic recording reservation for recording the specified program. It is also possible to automatically record the entire TV programs in which the artist is performing.

A fourth specified event is such a one in which, if a bar code as listed in the music information magazine or a CD rental shop information magazine, on which appears the artist information and occasionally the URL information, the user is able to browse the relevant information, extremely readily, without the need to manually input the URL. The user can lightly purchase CDs or the concert tickets on the spot. In the music information journal, the bar code is printed on an article for new music titles. Based on this article, the information of the relevant CD is displayed. The supplementary information of the products or artists, automatically demonstrated on the Internet browser in the first specified event, may also be displayed. The CD or EMD may be viewed or listened to, or purchased on the spot.

A fifth event is such a one in which, if the DB enclosed in the HDD can be updated periodically, the later information can be acquired, without taking pains to connect to the Internet from time to time.

A sixth event is such a one in which a printer, not shown, has the bar code printing function, and each service provider distributes special bar codes to users, by this printer, so that only the user in possession of the bar code is able to benefit from the privilege.

Since the present embodiment of the information processing system enables the above-described respective specified events, the music information can readily be acquired not only from the CD or the DVD but also from various other media. The user who connects his/her computer to the Internet is able to automatically acquire further numerous information and hence the present system may be said to be entertainment-oriented. If the present invention comes into popularity, product sale on the Internet or the music distributing EMD service will be more familiar to the user.

What is claimed is:

1. An information processing apparatus comprising:
product information retrieving means for reading out a code input by a code inputting device for retrieving the product information;
relevant information acquisition means for acquiring the relearnt information pertinent to the product information retrieved by said product information retrieving means; and
display means for displaying the relevant information acquired by said relevant information acquisition means.

2. The information processing apparatus as recited in claim 1 further comprising:
additional information acquisition means for connecting from the relevant information demonstrated by said display means to a Web site over the network for acquiring the additional information; said display means also demonstrating said additional information.

3. The information processing apparatus as recited in claim 1 wherein said relevant information acquisition means acquires the relevant information pertinent to both a given product and a product different from said given product, using the product information of said given product retrieved by said product information retrieving means and an identification code identifying said different product, as retrieving keys; said display means demonstrating the relevant information pertinent to both of said products.

4. The information processing apparatus as recited in claim 3 further comprising:
additional information acquisition means for connecting from the relevant information demonstrated by said display means to a Web site over a network for acquiring the additional information; said display means further demonstrating the additional information acquired by said additional information acquisition means.

5. The information processing apparatus as recited in claim 1 wherein said product information retrieving means refers to a periodically updatable database to read out the product information.

6. The information processing apparatus as recited in claim 1 wherein said relevant information acquisition means acquires said relevant information from a Web site provided on a network.

7. An information processing method comprising:
a code inputting step of inputting a code;
a product information retrieving step of reading out the code input from said code inputting step to retrieve the product information;
a relevant information acquisition step of acquiring the relevant information pertinent to the product information as retrieved by said product information retrieving step; and
a relevant information displaying step of demonstrating the relevant information acquired by said relevant information acquisition step.

8. The information processing method as recited in claim 7 further comprising:
an additional information acquisition step of connecting from the relevant information demonstrated at said display step to a Web site over a network for acquiring the additional information; and
an additional information displaying step of demonstrating the additional information acquired at said additional information acquisition step.

9. The information processing method as recited in claim 7 comprising:
acquiring the relevant information pertinent to both a given product and a product different from said given product, using the product information of said given product retrieved by said product information retrieving step and an identification code identifying said different product, as retrieving keys; and
demonstrating the relevant information pertinent to both of said products.

10. The information processing method as recited in claim 9 further comprising:
an additional information acquisition step of connecting from the relevant information demonstrated in said display step to a Web site over a network for acquiring the additional information; and
an additional information displaying step of demonstrating the additional information acquired in said additional information acquisition step.

11. The information processing method as recited in claim 7 wherein said product information retrieving step refers to a periodically updatable database to read out the product information.

12. The information processing method as recited in claim 7 wherein said relevant information acquisition step acquires said relevant information from a Web site arranged on a network.

13. An information processing program comprising:
a code inputting step of inputting a code;
a product information retrieving step of reading out the code input from said code inputting step to retrieve the product information;
a relevant information acquisition step of acquiring the relevant information pertinent to the product information as retrieved by said product information retrieving step; and
a relevant information displaying step of demonstrating the relevant information acquired by said relevant information acquisition step.

14. The information processing program as recited in claim 13 further comprising:
an additional information acquisition step of connecting from the relevant information demonstrated in said display step to a Web site over a network for acquiring the additional information; and
an additional information displaying step of demonstrating the additional information acquired in said additional information acquisition step.

15. The information processing program as recited in claim 13 wherein said relevant information acquisition step acquires the relevant information pertinent to both a given product and a product different from said given product, using the product information of said given product retrieved by said product information retrieving step and an identification code identifying said different product, as retrieving keys; said display step demonstrating the relevant information pertinent to both of said products.

16. The information processing program as recited in claim 15 further comprising:
an additional information acquisition step of connecting from the relevant information demonstrated in said display step to a Web site of a third party over a network for acquiring the additional information; and
an additional information displaying step of demonstrating the additional information acquired at said additional information acquisition step.

17. The information processing program as recited in claim 13 wherein said product information retrieving step refers to a periodically updatable database to read out the product information.

18. The information processing program as recited in claim 13 wherein said relevant information acquisition step acquires said relevant information from a Web site arranged on a network.

19. An information processing system comprising:
a code inputting device of inputting a code;
a product information retrieving device reading out the code input from said code inputting step, retrieving the product information, acquiring the relevant information based on the product information and demonstrating the relevant information; and
an information supplying device for connecting to said information processing device over a network.

20. The information processing system as recited in claim 19 wherein said information processing apparatus includes
product information retrieving means for reading out a code input by a code inputting device for retrieving the product information;
relevant information acquisition means for acquiring the relevant information pertinent to the product information retrieved by said product information retrieving means; and
display means for demonstrating the relevant information acquired by said relevant information acquisition means; wherein
connection is made from the relevant information demonstrated in display means to said information providing device of a third party over a network to acquire the additional information for demonstration on said displaying means.
